(19) United States
(12) Patent Application Publication
(10) Pub. No.: US 2008/0144181 A1
(43) Pub. Date: Jun. 19, 2008

(54) Reflex Sight

(75) Inventor: Zeev Pniel, Petach Tikva (IL)

Correspondence Address: Martin D. Moynihan;PRTSI, Inc., P.O. Box 16446, Arlington, VA, 22215, US

(73) Assignee: ITLOptronics Ltd., Petach-Tikva (IL)

(21) Appl. No.: 11/886,092

(22) PCT Filed: Mar. 13, 2006
(86) PCT No.: PCT/IL2006/000328

§ 371 Date: Sep. 11, 2007

(30) Foreign Application Priority Data
Mar. 21, 2005 (IL) 167567

(51) Int. Cl. G02B 27/10; G02B 23/10

(52) U.S. Cl. 359/618; 356/251

(57) ABSTRACT

A reflex sight includes a beam combiner having high light-transmissivity with respect to one part of the visible spectrum to permit viewing a target field along a first optical axis of the beam combiner, and high light-reflectivity with respect to another part of the visible spectrum to permit viewing an aiming-mark superimposed on the target field when projected through the beam combiner along a second optical axis; and an aiming-mark projector for projecting the aiming-mark along the second optical axis of the beam combiner for viewing as a superimposition on the target field when viewed along the first optical axis. The aiming-mark projector includes an aiming-mark device effective, when illuminated, to project the aiming-mark along the second optical axis of the beam combiner; and a powered light source including a power supply for energizing the light source. The aiming-mark device is exposed to a passive light source and the powered light source to enable utilizing the passive light source and/or the powered light source for illuminating the aiming-mark device.

### FIELD AND BACKGROUND OF THE INVENTION

The present invention relates to sighting or aiming devices, and particularly to a reflex sight for use with weapons, cameras, and the like.

Reflex sights are used for superimposing an aiming-mark, such as a reticle, on a target field viewed by the observer. The target field is viewed through a beam combiner having high light-transmissivity with respect to one part of the visible spectrum to permit viewing the target field along a first optical axis, and high light-reflectivity with respect to another part of the visible spectrum to permit viewing the aiming-mark superimposed on the target field.

If the combiner is chosen to have high light-transmissivity with respect to the target field, the aiming-mark will be less viewable particularly in brightly-lit target fields; and if the combiner is chosen to have high light-reflectivity with respect to the aiming-mark, the target field will be less viewable particularly in dimly-lit target fields.

However, it sometimes happens that the reflex sight is used under conditions where the lighting of the aiming-mark is completely different from the lighting of the target field. For example, if the target field is brightly lit but the observer using the reflex sight is located in a shaded area or a partially enclosed area such that the aiming-mark device is poorly lit, it may be difficult to perceive the aiming-mark when superimposed on the view of the target field.

### OBJECT AND BRIEF SUMMARY OF THE PRESENT INVENTION

An object of the present invention is to provide a reflex sight which has advantages in the above respect. Another object of the invention is to provide a reflex sight which can be effectively used during all light conditions.

According to one aspect of the present invention, there is provided a reflex sight, comprising: a beam combiner having high light-transmissivity with respect to one part of the visible spectrum to permit viewing a target field along a first optical axis of the beam combiner, and high light-reflectivity with respect to another part of the visible spectrum to permit viewing an aiming-mark superimposed on the target field when projected through the beam combiner along a second optical axis; and an aiming-mark projector for projecting the aiming-mark along the second optical axis of the beam combiner for viewing as a superimposition on the target field when viewed along the first optical axis; characterized in that the aiming-mark projector includes: an aiming-mark device effective, when illuminated, to project the aiming-mark along the second optical axis of beam combiner; and a powered light source including a power supply for energizing the light source; the aiming-mark device being exposed to a passive light source and the powered light source to enable utilizing the passive light source and/or the powered light source for illuminating the aiming-mark device.

According to another aspect of the present invention, there is provided a reflex sight comprising: a beam combiner having high light-transmissivity with respect to one part of the visible beam to permit viewing a target field along a first optical axis of the beam combiner, and high light-reflectivity with respect to another part of the visible spectrum to permit viewing an aiming-mark superimposed on the target field when projected through the beam combiner along a second optical axis perpendicular to the first optical axis; a reflector in the beam combiner for reflecting an image of the aiming-mark towards the second optical axis from a third optical axis parallel to and spaced from the first optical axis; an aiming-mark device aligned with the third optical axis of the beam combiner; and the aiming-mark device being exposed to a passive light source and the powered light source to enable utilizing the passive light source and/or the powered light source for illuminating the aiming-mark device, a powered light source including a power supply for energizing the light source.

One embodiment is described below wherein the reflex sight further comprises a dichroic prism having a first face facing the aiming-mark device, a second face facing the powered light source, and a third face facing the passive light source, such that the aiming-mark device can be selectively illuminated by the powered light source or by the passive light source.

Two further embodiments are described below not including a dichroic prism. In one of the latter embodiments, the reflex sight further comprises a diffuser for illuminating the aiming-mark device, the diffuser being exposed to ambient light and also to light from the powered light source. In another described embodiment, the reflex sight includes a light guide for illuminating the aiming-mark device, the light guide being exposed to ambient light and also to the light from the powered light source.

According to further features in the preferred embodiments of the invention described below, the reflex sight further includes a collimating lens between the reflector of the beam combiner and the aiming-mark device, and a diffuser between the first face of the dichroic prism and the aiming-mark device. In the described preferred embodiment, the aiming-mark device includes a negative mask of the aiming-mark, such as a reticle.

The power supply in the described preferred embodiments is controlled to energize or de-energize the powered light source, and also to control the illumination intensity produced by that light source. The powered light source may be, for example, a lamp, a liquid crystal display (LCD), or a light-emitting diode (LED). The passive light may be natural ambient light or background light from a tritium-excited beta lamp.

The embodiments of the invention described below are particularly for use with a weapon, and therefore the described reflex sight further comprises a mounting constructed for mounting the reflex sight on the barrel of a weapon.

As will be described more particularly below, reflex sights constructed in accordance with the foregoing features may be effectively used virtually under all lighting conditions.

Further features and advantages of the invention will be apparent from the description below.

### BRIEF DESCRIPTION OF THE DRAWINGS

The invention is herein described, by way of example only, with reference to the accompanying drawings wherein:

FIG. 1 illustrates a reflex sight constructed in accordance with a preferred embodiment of the invention to include a dichroic prism;

FIG. 2 illustrates a modification in the reflex sight of FIG. 1 not utilizing a dichroic prism; and

FIG. 3 illustrates another modification in the reflex sight of FIG. 1 also not utilizing a dichroic prism.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF THE PREFERRED EMBODIMENTS

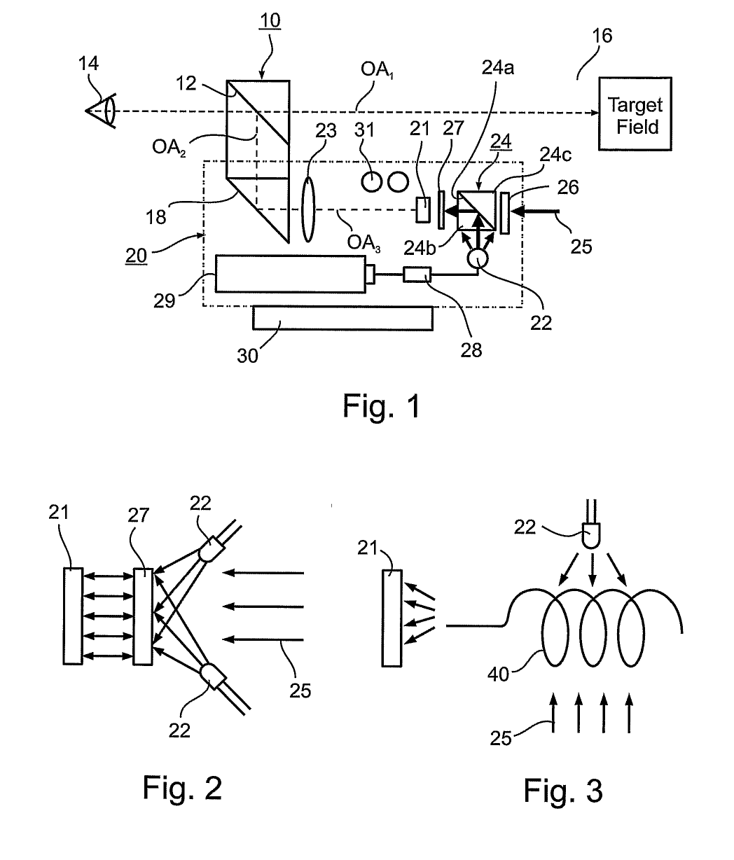

FIG. 1 schematically illustrates a reflex sight constructed in accordance with the present invention particularly useful for mounting on a rifle barrel, or other weapon.

The reflex sight illustrated in FIG. 1 includes a beam combiner, generally designated 10, incorporating a dichroic layer 12 having high light-transmissivity with respect to one part of the visible spectrum to permit viewing a target field along a first optical axis OA₁ aligned with the observer's eye 14 and the target field 16, and high light-reflectivity with respect to another part of the visible spectrum to permit viewing an aiming-mark superimposed on the target field when projected through the beam combiner along a second optical axis OA₂ perpendicular to optical axis OA₁. Beam combiner 10 thus includes a reflector 18 for reflecting an image of the aiming-mark towards the second optical axis OA₂ from a third optical axis OA₃ parallel to and spaced from optical axis OA₁.

FIG. 1 further schematically illustrates an aiming-mark projector, generally designated 20, for projecting the aiming-mark along optical axis OA₃ for reflection by reflector 18 along optical axis of OA₂ within the beam combiner 10. The aiming-mark is again reflected by the dichroic layer 12 towards the observer's eye 14 so as to be viewed as a superimposition on the target field when viewed along optical axis OA₁.

Insofar as described above, such reflex sights including beam combiners are well known and in widespread use particularly as aiming devices for weapons. However, as pointed out above, the known reflex sights are not equally effective under all light conditions. The reflex sight illustrated in FIG. 1, and particularly the aiming-mark projector generally designated by box 20 in FIG. 1, is constructed so as to enable the reflex sight to be equally effective under substantially all light conditions, from nighttime through bright light.

Aiming-mark projector 20 thus includes an aiming-mark device 21, e.g. in the form of a negative mask of a reticle, and a powered light source 22 for illuminating the aiming-mark device 21. An image of the aiming-mark is thus projected along optical axis OA₃ of the combiner, and is reflected by reflector 18 along optical axis OA₂ towards the dichroic layer 12 of the beam combiner 10, for viewing by the observer's eye 14 when viewing the target field 16 along optical axis OA₁, of the beam combiner. The aiming-mark projector 20 further includes a collimating lens 23 between the aiming-mark device 21 and reflector 18 for focusing the projected image of the aiming-mark at infinity, thereby enabling the aiming-mark to be clearly seen superimposed on all target fields.

Aiming-mark projector 20 schematically illustrated in FIG. 1 further includes a dichroic prism 24 between the powered light source 22 and the aiming-mark device 21. As shown in FIG. 1, dichroic prism 24 has a first face 24a facing the aiming-mark device 21, a second face 24b facing the powered light source 22, and a third face 24c defining a window for receiving passive light, such as natural ambient light as shown by arrow 25 in FIG. 1. The window defined by face 24c of dichroic prism 24 may also be illuminated by light from another passive light source, such as a tritium-excited beta lamp, as schematically shown at 26 in FIG. 1.

As further shown in FIG. 1, aiming-mark projector 20 further includes a diffuser 27 between face 24a of dichroic prism 24 and the aiming-mark device 21.

The powered light source 22 facing face 24b of dichroic prism 24 is selectively controllable as desired according to the prevailing light conditions. Thus, as shown in FIG. 1, the powered light source 22 is controllable by an on-off switch 28 for selectively energizing and de-energizing the light source, and by a controllable power supply 29 for controlling the intensity of illumination produced by the light source. The powered light source 22 may be, for example, a lamp, a liquid crystal display (LCD), or a light-emitting diode (LED).

As indicated above, the reflex sight illustrated in FIG. 1 is particularly for use on a weapon, such as a rifle. Accordingly, it includes a mounting device, schematically illustrated at 30, constructed for mounting the reflex sight on the barrel of a rifle. It also includes a bore-sight knob 31 for adjusting the bore-sight with respect to the rifle barrel.

The manner of using the reflex sight illustrated in FIG. 1 will be apparent from the above description. Thus, when the reflex sight is used during the daytime under normal or high-light conditions, power switch 28 would be turned off so as to de-energize the light source 22, thereby to use the natural ambient light entering the window at face 24a of dichroic prism 24 for illuminating the reticle mask 21. Its image is thus superimposed on the target field as viewed by the observer's eye 14 along optical axis OA₁ of combiner 10.

If the natural ambient light is relatively low, the tritium-excited beta lamp 26 may also be used for illuminating the reticle 21.

On the other hand, if the target field is brightly lit, but the observer is in a shaded or partially obscured area such that the natural ambient light is very low for illuminating this reticle, light source 22 may be energized by power switch 28 to illuminate the reticle. The amount of illumination may be varied by power supply 29 to produce the optimum illumination of reticle 21 for the particular lighting conditions involved.

FIG. 2 illustrates a modification in the construction of the reflex sight of FIG. 1 to avoid the need for the dichroic prism 24. Thus, instead of using a dichroic prism, (corresponding to prism 24 in FIG. 1), the reflex sight of FIG. 2 merely uses the diffuser 27 for illuminating the aiming-mark device 21. Thus, as shown in FIG. 2, diffuser 27 receives light from both the powered light source 22, and also the natural ambient light as indicated by arrows 25.

FIG. 3 illustrates a further modification also avoiding the need for a dichroic prism. In the modification of FIG. 3, the aiming-mark device (reticle) 21 is directly illuminated by a light guide 40, which light guide receives light from the powered light source 22 and also from the natural ambient light as indicated by arrows 25.

The reflex sights illustrated in FIGS. 2 and 3 are otherwise of the same construction as described above with respect to FIG. 1.

While the invention has been described with respect to several preferred embodiments, it will be appreciated that these are set forth merely for purposes of example, and that many other variations, modifications and applications of the invention may be made.

1. A reflex sight, comprising:
a beam combiner having high light-transmissivity with respect to one part of the visible spectrum to permit viewing a target field along a first optical axis of the beam combiner, and high light-reflectivity with respect to another part of the visible spectrum to permit viewing an aiming-mark superimposed on the target field when projected through the beam combiner along a second optical axis; and
an aiming-mark projector for projecting the aiming-mark along said second optical axis of the beam combiner for viewing as a superimposition on the target field when viewed along said first optical axis;
characterized in that said aiming-mark projector includes: an aiming-mark device effective, when illuminated, to project the aiming-mark along said second optical axis of the beam combiner; and a powered light source including a power supply for energizing the light source; said aiming-mark device being exposed to a passive light source and said powered light source to enable utilizing said passive light source and/or said powered light source for illuminating said aiming-mark device.

2. The reflex sight according to claim 1, wherein said aiming-mark projector further includes a dichroic prism having a first face facing said aiming-mark device, a second face facing said powered light source, and a third face facing said passive light source such that said aiming-mark device can be selectively illuminated by said powered light source and/or by said passive light source.

3. The reflex sight according to claim 2, wherein said aiming-mark projector is aligned with a third optical axis of the beam combiner spaced from and parallel to said first optical axis; and wherein said beam combiner includes a reflector for reflecting said aiming-mark from said third optical axis to said second optical axis within the beam combiner.

4. The reflex sight according to claim 3, wherein said aiming-mark projector further includes a collimating lens between said reflector of the beam combiner and said aiming-mark device.

5. The reflex sight according to claim 4, wherein said aiming-mark projector further includes a diffuser between said first face of the dichroic prism and said aiming-mark device.

6. The reflex sight according to claim 4, wherein said aiming-mark device includes a negative mask of the aiming-mark.

7. The reflex sight according to claim 1, wherein said reflex sight further comprises a diffuser for illuminating said aiming-mark device; said diffuser being exposed to the light of said passive light source and also to the light of said powered light source.

8. The reflex sight according to claim 1, wherein said aiming-mark device is exposed to the light of said passive light source and also to the light from said powered light source.

9. The reflex sight according claim 1, wherein said reflex sight further comprises a light guide for illuminating said aiming-mark device, said light guide being exposed to the light of said passive light source and also to the light from said powered light source.

10. The reflex sight according to claim 1, wherein said power supply is controlled to energize or de-energize said powered light source and also to control the illumination intensity produced thereby.

11. The reflex sight according to claim 1, wherein said powered light source is a lamp, a liquid crystal display (LCD), or a light-emitting diode (LED).

12. The reflex sight according to claim 1, wherein said passive light source is natural ambient light.

13. The reflex sight according to claim 1, wherein said passive light source is or includes a tritium-excited beta lamp.

14. The reflex sight according to claim 1, wherein the reflex sight further comprises a mounting constructed for mounting the reflex sight on the barrel of a weapon.

15. A reflex sight comprising:
a beam combiner having high light-transmissivity with respect to one part of the visible beam to permit viewing a target field along a first optical axis of the beam combiner, and high light-reflectivity with respect to another part of the visible spectrum to permit viewing an aiming-mark superimposed on the target field when projected through the beam combiner along a second optical axis perpendicular to said first optical axis;
a reflector in said beam combiner for reflecting an image of said aiming-mark towards said second optical axis from a third optical axis parallel to and spaced from said first optical axis;
an aiming-mark device aligned with said third optical axis of the beam combiner; and
a powered light source including a power supply for energizing the light source;
said aiming-mark device being exposed to a passive light source and said powered light source to enable utilizing said passive light source and/or said powered light source for illuminating the aiming-mark device.

16. The reflex sight according to claim 15, wherein said reflex sight further comprises a dichroic prism having a first face facing said aiming-mark device, a second face facing said powered light source, and a third face facing said passive light source such that said aiming-mark device can be selectively illuminated by said powered light source or by said passive light source.

17. The reflex sight according to claim 16, wherein said reflex sight includes a collimating lens between said reflector of the beam combiner and said aiming-mark device.

18. The reflex sight according to claim 17, wherein said reflex sight further includes a diffuser between said first face of the dichroic prism and said aiming-mark device.

19. The reflex sight according to claim 17, wherein said aiming-mark device includes a negative mask of the aiming-mark.

20. The reflex sight according to claim 15, wherein said reflex sight further comprises a diffuser for illuminating said aiming-mark device; said diffuser being exposed to the light of said passive light source and also to the light of said powered light source.

21. The reflex sight according to claim 15, wherein said aiming-mark device is exposed to the light of said passive light source and also to the light from said powered light source.

22. The reflex sight according claim 21, wherein said reflex sight further comprises a light guide for illuminating said aiming-mark device, said light guide being exposed to the light from said passive light source and also to the light from said powered light source.

23. The reflex sight according to claim 15, wherein said power supply is controlled to energize or de-energize said powered light source and also to control the illumination intensity produced thereby.

24. The reflex sight according to claim 15, wherein said powered light source is a lamp, a liquid crystal display (LCD), or a light-emitting diode (LED).

25. The reflex sight according to claim 15, wherein said passive light source is natural ambient light.

26. The reflex sight according to claim 15, wherein said passive light source is a tritium-excited beta lamp.

27. The reflex sight according to claim 15, wherein the reflex sight further comprises a mounting constructed for mounting the reflex sight on the barrel of a weapon.

28. (canceled)
